(19) United States
(12) Patent Application Publication
(10) Pub. No.: US 2026/0187481 A1
(43) Pub. Date: Jul. 2, 2026

(54) CROSS DIRECTIONAL HYPERPARAMETER TUNING

(71) Applicants: American Express Travel Related Services Company, Inc., New York, NY (US); Amex Canada Inc., Toronto (CA); American Express Company, New York, NY (US); American Express Innovation Lab Limitd, Dublin (IE); American Express National Bank, Sandy, UT (US)

(72) Inventors: Ajay Singh SHEKHAWAT, Jersey City, NJ (US); Hemanshu Bansal, Gurgaon (IN); Manmeet Singh Duggal, Phoenix, AZ (US); Nishkam Verma, New Delhi (IN); Rahul Jangir, Vivace (SG); Rohit Kumar, Udhampur (IN); Saptaka Hansda, Gurugram (IN); Shivam Chanan, Brampton (CA); Sumita Mathur, Gurgaon (IN); Man Chon U, Weston, FL (US); Saurabh Gupta, Phoenix, AZ (US)

(73) Assignees: American Express Travel Related Services Company, Inc., New York, NY (US); Amex Canada Inc., Toronto (CA); American Express Company, New York, NY (US); American Express Innovation Lab Limited., Dublin (IE); American Express National Bank, Sandy, UT (US)

(21) Appl. No.: 19/007,013

(22) Filed: Dec. 31, 2024

(51) Int. Cl. G06N 3/0985; G06N 5/01

(52) U.S. Cl. CPC G06N 3/0985; G06N 5/01

(57) ABSTRACT

Disclosed herein are system, method, and computer program product embodiments for using cross directional hyperparameter tuning. A system identifies a hyperparameter set to configure a first machine learning model, a first evaluation data set, and a machine learning evaluation process. The system determines a first tuned hyperparameter set for the first machine learning model by performing cross directional hyperparameter tuning, including iterating over the set of hyperparameters. At each iteration, the system selects a hyperparameter from the set, where the selected hyperparameter is a value within a range of values. The system iterates over the range of values, at each iteration, generates a score for the machine learning model via an evaluation process configured using the selected hyperparameter, set of hyperparameters, and the first evaluation data set. The system updates the selected hyperparameter. The system then saves the selected hyperparameter corresponding to a greatest score at the set of hyperparameters.

### BACKGROUND

### Field

This field is generally related to increasing machine learning training efficiency through cross directional hyperparameter tuning.

### Related Art

Machine learning is a process used to build a model, where the model is a representation of the thing to be learned. For example, machine learning may be used to build a classifier that identifies objects within images. Here, the model may include representations of detected objects. The model (e.g., the representations) is generated through a training process. Training involves iterating over examples (e.g. training data), generating predictions, and updating the model based on the prediction. For example, if the prediction is correct, values at the model associated with the prediction may be increased. If the prediction is incorrect, values at the model associated with the incorrect predicted answer may be decreased, while values associated with the correct answer may be increased.

### BRIEF SUMMARY

Training details are dependent upon various factors such as the model type, task, training data type, amount of training data, etc. Training is also dependent on the hardware resources available. Not only is sufficient memory required to store the training data, training also requires enough processing power to execute the learning process. For example, it is likely infeasible to train a large language model on thousands of gigabytes of data using a personal laptop due to space and performance scarcity.

Oftentimes, hyperparameters are used to define the parameters of the training process. For example, hyperparameters may define the number of training data examples to use, the number of times to iterate over the training data (e.g., epochs), the number of items to train on before updating the model (e.g., batch size), and learning rate. Since the hyperparameters are used to configure training, they directly impact the resulting model. Identifying optimal hyperparameters is often computationally complex, because all possible combinations are tried. For a large model, this results in a vast expenditure of computing resources.

Disclosed herein are system, apparatus, device, method and/or computer program product embodiments, and/or combinations and sub-combinations thereof, for using cross directional searching for hyperparameter tuning. This disclosure describes a system that identifies optimal hyperparameters to train a machine learning model. The system may leverage a two-step algorithm to identify the optimal hyperparameters for a given machine learning model. Once the optimal hyperparameters are identified, the model is trained and deployed for use on a network.

### BRIEF DESCRIPTION OF THE DRAWINGS

The accompanying drawings are incorporated herein and form a part of the specification.

FIG. 1 depicts a block diagram of a machine learning environment, according to some embodiments.

FIG. 2 illustrates a decision tree of an exemplary method of a first stage for cross directional hyperparameter tuning, according to some embodiments.

FIG. 3 illustrates a decision tree of an exemplary method of a second stage for cross directional hyperparameter tuning, according to some embodiments.

FIG. 4 depicts a flowchart illustrating a method for cross directional hyperparameter tuning, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for using cross directional searching to identify optimal hyperparameter values. Hyperparameter values may be used to configure a machine learning training process. Once the optimal hyperparameter values are identified via cross directional searching, the model may be trained and deployed.

Hyperparameters may be used to determine various aspects of the training process such as: (1) learning rate; (2) number of training epochs; (3) training batch size; (4) number of nodes in a network; (5) number of layers in a network; and (6) number of branches in a decision tree. Model performance is a downstream effect of hyperparameter selection. For example, one hyperparameter may be number of training epochs (e.g., the number of iterations over the entire training data set). If the number of epochs is set at two, the model will train over the data set twice. A model trained using a low number of epochs (e.g., one) may perform worse than a model trained using a higher number of epochs (e.g., 100). This occurs because the model trained using one epoch hasn't encountered nearly as many examples as the model trained using 100 epochs. Thus, a significant factor in training a machine learning model is the identification of optimal hyperparameters in order to maximize the learning potential of the model.

A counterintuitive aspect of identifying optimal hyperparameters is that increasing the value of the hyperparameter may not improve model performance. As stated above, epochs may be used to determine how many times the model should iterate over the entire training data set. It may seem that increasing the number of epochs would correlate with increased model performance. However, machine learning models may suffer from overfitting. Overfitting is a phenomenon where the model trains fails to generalize. For example, if the number of epochs is drastically increased, the model may become so specific to the training data set that it fails to generate correct predictions when it encounters new data. Therefore, optimal hyperparameter values may often be those somewhere between two extremes.

Current systems identify hyperparameters by performing a grid search (e.g., brute force search). Grid search involves trying all possible hyperparameter combinations, in order to find the optimal set. This process is very resource intensive, because the operation grows exponentially for each additional hyperparameter. For example, with two hyperparameters, each having two possible values, there are four hyperparameter combinations to evaluate. However, if a third hyperparameter is added, also with two possible values, there are nine hyperparameter combinations to evaluate. This process is extremely inefficient, consuming resources that could be otherwise devoted to model training and tuning.

The cross directional hyperparameter search, described below, solves this problem by efficiently identifying optimal hyperparameters that may be used to train a machine learning model. Cross directional search achieves improved performance by choosing the highest performing parameters at each iteration, resulting in an optimal set of hyperparameters in fewer iterations. The algorithm involves two stages, an exploratory move stage, and a fine tuning stage.

The exploratory stage may involve iterating over the set of hyperparameters. At each iteration, a hyperparameter is selected to be evaluated along a range of values. The range may be predefined and have a corresponding step size. The step size may be a value used to update the hyperparameter at each iteration. For example, if the range is [1-10] and the step size is 0.5, then the hyperparameter value would move along the range as follows: 1; 1.5; 2; 2.5; etc.

An evaluation process may be used to determine how the hyperparameter value contributes to model performance. For example, at each iteration over the range of values, a score may be generated for the machine learning model using the evaluation process. The evaluation process may be configured using the selected hyperparameter and the set of hyperparameters. The evaluation process may differ based on the type of machine learning model. The evaluation process may involve training the model using the hyperparameters, and then testing the model. Hyperparameters resulting in improved model performance may be used over hyperparameters with worse model performance. The performance metric or measure may vary based on the model type. For example, a neural network may determine performance using f-score, whereas a decision tree may determine performance using gini impurity.

While the selected hyperparameter is updated according to a step size, the remaining hyperparameters remain fixed. Fixing the remaining values is beneficial so that the optimal value of the selected hyperparameter is determined. If multiple hyperparameters are updated at each iteration, an increase in model performance could be attributable to any of the updated hyperparameters. However, if only a single hyperparameter is changed, a change in model performance can be attributed to the single hyperparameter update.

Once the model has been evaluated using the selected hyperparameter along the range, the value corresponding to maximum model performance (e.g., greatest evaluation score) is saved. For example, the model may have been evaluated using hyperparameter values: 1, 1.5, and 2. Each value may have resulted in respective evaluation scores of 70%, 73%, and 72.5%. Since 1.5 had the highest evaluation score, it will be saved as the new value for that hyperparameter. Next, a second hyperparameter from the set is identified to be evaluated. Similarly, all hyperparameters, other than the selected one, are fixed, while the selected hyperparameter is updated along a range and the model is evaluated. Once the hyperparameter value corresponding to greatest model performance is identified and saved, the process is repeated for each remaining hyperparameter within the set of hyperparameters.

Stage one may be repeated for a predefined number of iterations. At each iteration, the range for each hyperparameter may be updated. For example, the range may be centered around the hyperparameter value identified from the previous iteration. For example, 0.6 may have been identified as the optimal value for hyperparameter X during the first iteration. The first iteration may have used a range from [0-1], with a step size of 0.1. At the second iteration, the range may be centered around 0.6, such that the new range is: [0.1-1.1]. Updating the range value is beneficial to try and hone in on the optimal hyperparameter value.

At the second stage, the hyperparameters are fine tuned. Fine tuning involves: (1) calculating a range using the hyperparameter value from stage one, and a deviation factor; (2) determining an optimal hyperparameter value within the range; (3) updating the deviation factor; and (4) repeating the process using the optimal hyperparameter value identified from within the range. For example, hyperparameter X may be selected for fine tuning using 0.6 from stage one. The deviation factor may start at 10%. The range may be determined by taking the product of hyperparameter X and the deviation factor, then both adding and subtracting that value to X. Using the example above, the resulting range would be [0.54, 0.6, 0.66]. The model may then be evaluated at each value along this range. The value corresponding the greatest performance or evaluation score may be used in the next iteration. For example, if 0.54 corresponded to the greatest model performance, it may be used as the selected hyperparameter value at the next iteration.

At each iteration, the deviation factor may be updated. In some embodiments, the deviation factor may be reduced. For example, the deviation factor may be reduced from 10% to 9%. The process may then be repeated until the deviation factor is reduced to a predefined stopping factor. For example, the deviation factor may start at 10%, and be reduced at each iteration by 1, until it reaches 1%. In this example, the hyperparameter value would be evaluated at ranges calculated using [10%, 9%, . . . 1%]. The fine tuning process may then be used to evaluate the next hyperparameter in the set. For example, X may have represented number of epochs, and subsequently, fine tuning may be used to optimize Y (e.g., number of nodes in a neural network).

The process described above achieves a technical improvement to the field of machine learning. By identifying optimal hyperparameter values, and then focusing on those values at subsequent iterations, global optimal hyperparameter values are able to be identified much faster and more accurately than prior art systems. Prior art system may use a grid search approach, trying all possible combinations for all hyperparameters. This brute force approach is resource intensive because there may be millions or billions of combinations to attempt. The sheer number of combinations also renders manual selection impossible as well. In contrast, cross directional hyperparameter tuning focuses on identifying a first set of optimal hyperparameter values, and then fine tuning them by iteratively shrinking the space of possible hyperparameter values. This process will result in faster hyperparameter identification while requiring fewer resources (e.g., memory, CPU). This also will result in more accurate machine learning models. As discussed above, hyperparameter selection impacts model performance because the hyperparameters are used to configure the training process, and model performance is a direct result of training. Therefore, using cross directional hyperparameter tuning to identify optimal hyperparameters will lead to more accurate models, created over less time while having consumed fewer resources.

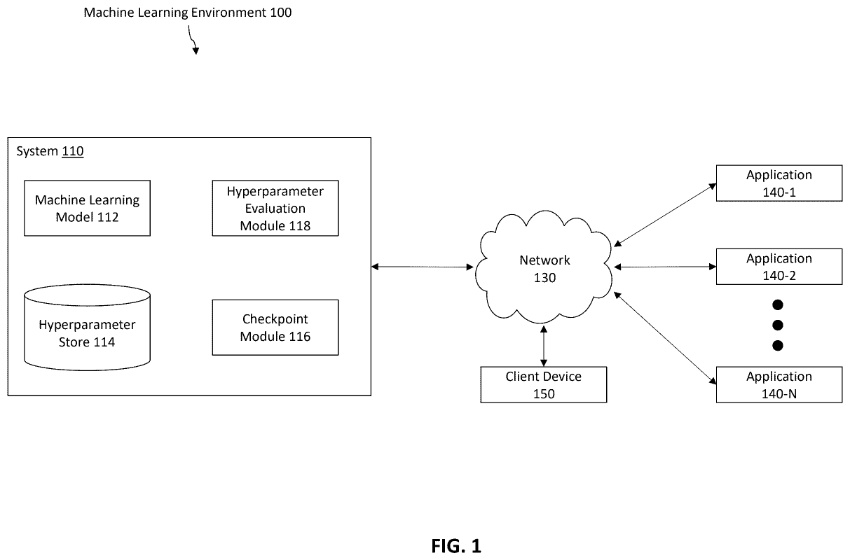

FIG. 1 depicts a block diagram of a machine learning environment 100, according to some embodiments. Machine learning environment 100 includes system 110, network 130, application 140, and client device 150.

System 110 includes machine learning model 112, hyperparameter store 114, and checkpoint module 116.

Machine learning model 112 may be a machine learning model using any architecture or design. For example, machine learning model may be a decision tree, support vector machine, neural network, convolutional neural network, recurrent neural network, generative adversarial network, or transformer model. Machine learning model 112 may be designed to input and output various types of data. For example, machine learning model 112 may input and train using images, video, text, audio, sensor data, or any combination thereof. Similarly, machine learning model 112 may predict, and thereby generate, image, video text, audio, sensor data, or any combination thereof. Machine learning model 112 may be trained on a data set using a set of hyperparameters. Although a single machine learning model 112 is depicted, system 110 may include multiple machine learning models 112.

The set of hyperparameters may be stored at hyperparameter store 114. Hyperparameter store 114 may be any memory device. The set of hyperparameters may be used to configure the training process. In some embodiments, a hyperparameter may be used for any type of machine learning model 112. For example, learning rate, number of training examples, number of test examples, batch size, and number of epochs may all, or a subset thereof, may be used when configuring the training process for any machine learning model 112.

In some embodiments, the same hyperparameter, although having different values, may be used for different types of models. For example, a decision tree and a neural network may both use hyperparameters for: (1) number of epochs; (2) learning rate; and (3) batch size. In some embodiments, a hyperparameter may be unique to a model type. For example, a neural network may have hyperparameters defining: (1) number of layers; (2) number of nodes per layer; (3) activation function; and (4) drop-out rate. In contrast, a decision tree may use hyperparameters for: (1) maximum number of steps; (2) number of keys; (3) number of trees; (4) minimum child weight; and (5) tree depth.

Hyperparameter store 114 may be organized according to any scheme. For example, hyperparameter store 114 may group hyperparameters by machine learning model 112 they are used for. For example, hyperparameter store 114 may group a first set of hyperparameters associated with a first machine learning model 112-1, and a second set of hyperparameters associated with a second machine learning model 112-2. In some embodiments, hyperparameter store 114 may be updated through the cross directional hyperparameter tuning process. Hyperparameter store 114 may be initialized with a starting set of hyperparameters for machine learning model 112. As will be discussed in more detail below, client device 150 may set the initial hyperparameters for machine learning model 112.

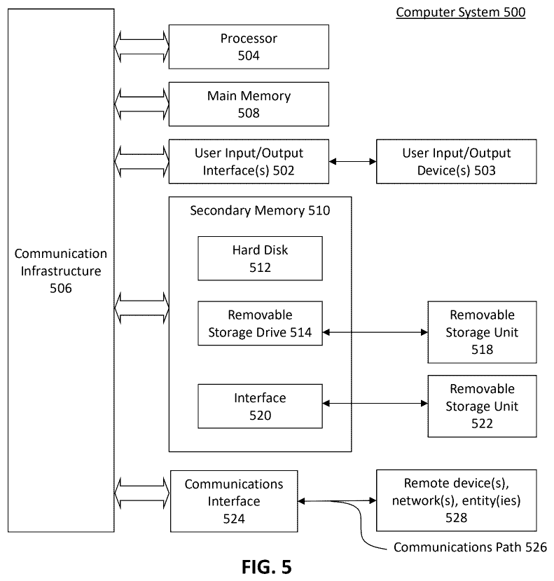

Hyperparameter evaluation module 118 may be a computer system such as computer system 500 described with reference to FIG. 5. Hyperparameter evaluation module 118 may be a client system such as a desktop workstation, laptop or notebook computer, netbook, tablet, smart phone, and/or other computing device that may be using an enterprise computing system.

Hyperparameter evaluation module 118 may perform the cross directional hyperparameter tuning process to identify optimal hyperparameters for machine learning model 112. Hyperparameter evaluation module 118 may retrieve hyperparameters corresponding to machine learning model 112 from hyperparameter store 114.

Hyperparameter evaluation module 118 may begin the process by retrieving the initial range of hyperparameters from hyperparameter store 114. As stated above, hyperparameter store 114 may include an initial set of hyperparameters for evaluation. This initial set may include the hyperparameters to evaluate (e.g., learning rate, number of epochs, batch size) and a value range for each hyperparameter. The value range may include one or more values for the hyperparameter to be evaluated at. For example, learning rate may have a value range of: [0.1, 0.3, 0.5, 0.7, 0.9]. In some embodiments, the hyperparameter value range may be defined by referencing a start value, end value, and step size. The start value may be the initial hyperparameter value, and the end value may be the final hyperparameter value to be evaluated. Hyperparameter evaluation module 118 may increment the hyperparameter value, at each iteration, according to the step size. For example, a learning rate range may be defined as: (1) start value: 0.1; (2) end value: 0.9;and step size: 0.1. Here, the learning rate may be evaluated at: [0.1, 0.2, 0.3, . . . 0.9].

In some embodiments, each hyperparameter may have a default value range. For example, learning rate may have a default value range of: [0.1, 0.3, 0.5, 0.7, 0.9] and epochs may have a default value range of: [100, 1,000; 10,000; 1,000,000]. In some embodiments, client device 150 may determine the value range for each hyperparameter. For example, client device 150 may interact with an interface at system 110 to define: (1) hyperparameters; and (2) value ranges for each hyperparameter.

As discussed above, multiple hyperparameters may be evaluated by hyperparameter evaluation module 118. For example, learning rate, batch size, and epoch size may all be evaluated for machine learning model 112. In some embodiments, hyperparameter evaluation module 118 may randomly select an order of hyperparameters to evaluate. In some embodiments, client device 150 may determine an order of hyperparameters to evaluate. For example, client device 150 may configure hyperparameter evaluation module 118 to first select learning rate, then batch size, and then number of epochs.

As described above, hyperparameter evaluation module 118 may perform the cross directional search process. The cross directional search involves two stages, an exploratory stage and a fine tuning stage. During the exploratory stage, hyperparameter evaluation module 118 identifies a first hyperparameter and its corresponding value range, while fixing the other hyperparameters. Hyperparameter evaluation module 118 may then perform the evaluation process for the selected hyperparameter along its value range. For example, if the selected hyperparameter is learning rate and it has a value range of: [0.1, 0.3, 0.5, 0.7, 0.9], hyperparameter evaluation module 118 may evaluate machine learning model 112 at each value along the range (e.g., 0.1. 0.9). Hyperparameter evaluation module 118 may then determine which hyperparameter value (e.g., learning rate value) corresponds to the maximum model performance. For example, learning rate 0.7 may have resulted in greatest model performance. Hyperparameter evaluation module 118 may then fix learning rate at 0.7, and repeat the process for the remaining hyperparameters. Model performance may be determined by computing a metric or evaluation score. The evaluation score may be based on the model type. For example, if the model is a neural network, the score may be determined using one of accuracy, precision, recall, and f-score. If the model is a decision tree, the score may be determined using one of gini impurity, information gain, or true positive rate.

For example, number of epochs may be the next hyperparameter to evaluate. Number of epochs may have a value range of: [1, 1000, 10000]. Here, hyperparameter evaluation module 118 will evaluate machine learning model 112, for each epoch value (e.g., 1, 1000, 10000) while learning rate remains fixed at 0.7. Hyperparameter evaluation module 118 may save the epoch value corresponding to highest model performance. For example, 1000 epochs may have resulted in the greatest model performance according to the evaluation metric. Hyperparameter evaluation module 118 will perform this process for each hyperparameter.

Hyperparameter evaluation module 118 may repeat the exploratory move process a predefined number of iterations. In some embodiments, hyperparameter evaluation module 118 may use a default number of iterations (e.g., 10, 100, 1000). In some embodiments, client device 150 may set the number of iterations for the exploratory move process.

At each iteration, optimal values identified from the previous iteration may be used. For example, learning rate and number of epochs may be the hyperparameters being evaluated. Additionally, the number of iterations for the exploratory process may be defined at two. On the second iteration the learning rate will be evaluated but the number of epochs will be the optimal value identified on the first iteration (e.g., 1000). As discussed above different combinations of hyperparameter values may combine to affect overall machine learning model's 112 performance. Thus, the first hyperparameter to be evaluated (e.g., learning rate), will likely benefit from identifying optimal values for other hyperparameters (e.g., number of epochs, batch size). Therefore, by performing the exploratory move process multiple iterations, hyperparameters evaluated earlier in the order are optimized in light of those evaluated later in the order. For example, learning rate may be updated from 0.7 to 0.8, using the new epoch value (e.g., 1000).

In some embodiments, the exploratory move process may repeat until changes in hyperparameter values are below a certain threshold. For example, if the change in value between iterations is below a predefined threshold (e.g., 10%), that hyperparameter value may no longer be updated during subsequent iterations of the exploratory move process. For example, on the first iteration, the optimal learning rate was 0.7, and on the second iteration, the learning rate was updated to 0.75. Since 0.75 is within a 10% of 0.7, the learning rate may be fixed for subsequent iterations of the exploratory move process. This may be beneficial to further save computing resources and prevent overfitting.

As a result, at the end of the exploratory stage, hyperparameter evaluation module 118 may have identified optimal hyperparameter values along the predefined range of values. Using the examples above, hyperparameter evaluation module 118 may have determined 0.7 to be the optimal learning rate from [0.1, 0.3, 0.5, 0.7, 0.9] and 1000 epochs from [1, 1000, 10000].

Hyperparameter evaluation module 118 may next perform the fine-tuning stage of cross directional search algorithm. As stated above, fine-tuning determines the optimal hyperparameter value, based on the output of the exploratory stage of the process. The fine-tuning process involves selecting a hyperparameter value, calculating a range based off the hyperparameter value and a deviation factor, evaluating the model along that range, and identifying the hyperparameter value from the range corresponding to greatest model performance.

Specifically, fine tuning begins by selecting the optimal hyperparameter value identified in the exploratory move stage (e.g., 0.7 learning rate and 1000 epochs). Next, a range of deviation factors is identified. Deviation factors may be a range of percentages, used to reduce the hyperparameter value until a global optimum is identified. For example, deviation factors may be [10%, 9%, 8%, . . . 1%]. A range is then determined by combining a deviation factor with the hyperparameter value. For example, a range may be determined by multiplying a deviation factor by the hyperparameter value, and then both adding and subtracting the result to the hyperparameter value. For example, learning rate of 0.7 is multiplied by 10% to determine a range of learning rates: [0.63, 0.7, 0.77]. Next, hyperparameter evaluation module 118 evaluates machine learning model 112, at each value along the range, while the remaining hyperparameters are fixed. Hyperparameter module 118 may then select the value along the range corresponding to the greatest performance, and repeat the process for each remaining deviation factor. For example, the process may be repeated using the value with the greatest performance (e.g., 0.77) and a new deviation factor (e.g., 9%). Fine tuning is then repeated for each hyperparameter. For example, once learning rate is evaluated along deviation factors [10%, 9%, 8%, . . . 1%], the same process may be performed for epochs along [10%, 9%, 8%, . . . 1%].

In some embodiments, hyperparameters may have different deviation factor ranges. For example learning rate may have a deviation factor range [10%, 9%, 8%, . . . 1%] whereas epochs may have a deviation factor range [5%, 4%, 3%]. In some embodiments, hyperparameter evaluation module 118 may utilize a default deviation factor range for all hyperparameters. In some embodiments, hyperparameter evaluation module 118 may utilize separate default deviation factor ranges for each hyperparameter. In some embodiments, client device 150 may determine deviation factor range for each hyperparameter.

Hyperparameter evaluation module 118 may save the hyperparameters values determined at the end of the fine tuning process. Hyperparameter evaluation module 118 may save the values at hyperparameter store 114. As a result, hyperparameter evaluation module 118 may identify unique hyperparameter values for each machine learning model 112. For example, a first set of tuned hyperparameters for a first machine learning model 112 using the evaluation process and the set of hyperparameters, where the first set of tuned hyperparameters are unique to the first machine learning model 112 may be determined. Additionally, a second set of tuned hyperparameters for a second machine learning model 112 based on evaluating the second machine learning model 112 using the evaluation process and the set of hyperparameters, where the second set of tuned hyperparameters are unique to the second machine learning model 112 may also be determined.

For example, the first machine learning model 112 may be a neural network trained to perform natural language processing tasks using English text. A second machine learning model 112 may also be a neural network trained to perform natural language tasks using Spanish text. Although the models may have the same configuration (e.g., same number of nodes, same number of layers), the different training data (e.g., English vs. Spanish text) may require different hyperparameters to optimize each model. The optimal hyperparameters may be achieved much faster, and with higher accuracy by performing cross directional hyperparameter tuning as opposed to a brute force search.

The machine learning models 112 may then be trained and deployed within network 130. For example, first machine learning model 112 may be trained using the first set of tuned hyperparameters and a first set of training data. Additionally, the second machine learning model 112 may be trained using the second set of tuned hyperparameters and a second set of training data. The models may then be deployed. For example, the first machine learning model 112 may be deployed on a first client device 150-1, and the second machine learning model 112 may be deployed on a second client device 150-2. Once deployed, machine learning model 112 may receive queries and generate predictions on network 130.

Hyperparameter evaluation module 118 may evaluate hyperparameters until a condition is reached. The condition may include one or more states at which the cross directional searching is terminated. For example, a termination condition may be defined as an evaluation score for the selected hyperparameters. Once the threshold evaluation score is reached, the process may stop. For example, if machine learning model 112 is a neural network and the hyperparameters are evaluated by calculating an F score, hyperparameter evaluation module 118 may stop the cross directional process, and save the set of hyperparameters, when the F1 score reaches 0.85. Similarly, if machine learning model 112 is a decision tree and gini impurity is used to evaluate the hyperparameters, cross directional process may terminate if the gini score is 0.1.

In some embodiments, the condition may relate to the number of combinations evaluated. For example, hyperparameter evaluation module 118 may terminate the cross directional search once 1 million, 10 million, 100 million, etc. combinations are evaluated.

In some embodiments, multiple conditions may be set, and the process may terminate when the first condition is met. For example, hyperparameter evaluation module 118 may be configured to terminate the search once: (1) a certain evaluation score is met; or (2) 10 million combinations are evaluated. Here, once a condition occurs, the process may terminate.

In some embodiments, client device 150 may determine when hyperparameter evaluation module 118 terminates the cross directional search process. As will be discussed below, client device 150 may interact with system 110 to configure hyperparameter evaluation module 118. Client device 150 may monitor hyperparameter evaluation module's 118 progress. For example, client device 150 may access an interface hosted by system 110 to monitor hyperparameter evaluation module's 118 progress. Client device 150 may use the interface to terminate the cross directional search process.

In addition to saving hyperparameters at hyperparameter store 114, hyperparameter evaluation module 118 may cause checkpoint module 116 to create checkpoints. Checkpoint module 116 may be used to save, load, and manage checkpoints during cross directional hyperparameter tuning. Checkpoint module 116 may be a computer system such as computer system 500 described with reference to FIG. 5. Checkpoint module 116 may be a client system such as a desktop workstation, laptop or notebook computer, netbook, tablet, smart phone, and/or other computing device that may be using an enterprise computing system.

A checkpoint may be a point during the cross directional hyperparameter tuning process where the progress up to that point is saved. A checkpoint may be written to a file. A checkpoint may include an identifier corresponding to machine learning model 112, the previous hyperparameter combinations evaluated, and hyperparameter combinations that have yet to be evaluated. In some embodiments, a checkpoint may further include details regarding the evaluation of the previous hyperparameter combinations. Evaluation details, for each previous hyperparameter combination, may include how the hyperparameter combination was evaluated such as the metric used (e.g., gini impurity, f1 score), the evaluation score, and what data was used for the evaluation.

Hyperparameter evaluation module 118 may alert checkpoint module 116 when to create a checkpoint. Hyperparameter evaluation module 118 may create checkpoints via checkpoint module 116 at various points. For example, hyperparameter evaluation module 118 may cause a checkpoint to be created after a predefined number of hyperparameter evaluations. Hyperparameter evaluation module 118 may create a checkpoint once a certain evaluation score is achieved. For example, a checkpoint may be created if a certain gini impurity or f1 score is achieved.

To create a checkpoint, hyperparameter evaluation module 118 may send an identifier of machine learning model 112, a previous hyperparameter combination, and a future hyperparameter combination. As stated above, hyperparameter evaluation module 118 may further include evaluation details for a previous hyperparameter combination. Checkpoint module 116 may write the received information to a file. Checkpoint module 116 may create a separate file for each machine learning model 112. In this embodiment, multiple checkpoints for machine learning model 112 may exist within the same file. In some embodiments, checkpoint module 116 may include checkpoints for multiple machine learning models 112 in a single file. In some embodiments, checkpoint module 116 may overwrite a previous checkpoint. For example, system 110 may configure checkpoint module 116 to maintain a maximum of five checkpoints. Here, when a sixth checkpoint is created, checkpoint module 116 may overwrite the earliest checkpoint created. In some embodiments, there may be no limit on the number of checkpoints created.

Hyperparameter evaluation module 118 may load a checkpoint. Hyperparameter evaluation module 118 may send an identifier of the machine learning model 112 being evaluated to checkpoint module 116. Checkpoint module 116 may then identify a file including checkpoints for the identified machine learning model 112. Once the checkpoint is identified, hyperparameter evaluation module 118 may evaluate machine learning model 112 using the future hyperparameter combination(s) in the checkpoint.

Client device 150 may interface with system 110 to configure and execute the cross directional hyperparameter tuning process. Client device 150 may be any entity in communication with system 110. Client device 150 may be a computer system such as computer system 500 described with reference to FIG. 5. Client device 150 may be a client system such as a desktop workstation, laptop or notebook computer, netbook, tablet, smart phone, and/or other computing device that may be using an enterprise computing system.

Client device 150 may interact with system 110 via network 130. Network 130 may be any type of computer or telecommunications network capable of communicating data, for example, a local area network, a wide-area network (e.g., the Internet), or any combination thereof. Network 130 may include wired and/or wireless segments. In some embodiments, network 130 may be a secure network.

Client device 150 may configure system 110 to perform cross directional hyperparameter tuning. For example, client device 150 may indicate system 110 machine learning model 112 to be evaluated. This may be accomplished via a GUI hosted by system 110. Client device 150 may further configure hyperparameter evaluation module 118 for the cross directional search algorithm. For example, client device 150 may determine: (1) which hyperparameters are evaluated; (2) initial hyperparameter values; (3) condition(s) at which to terminate the cross directional tuning process; and (5) an evaluation process to use.

In some embodiments, system 110 may provider alerts to client device 150. For example, system 110 may alert client device when hyperparameter evaluation module 118 has created a checkpoint, encountered an error, or completed the cross directional hyperparameter tuning process.

Client device 150 may further interact with checkpoint module 116. For example, client device 150 may access checkpoints created by checkpoint module 116. Client device 150 may delete checkpoints created, determine when checkpoints should be created, create checkpoints, and determine the number of checkpoints to be stored. For example, client device 150 may access the checkpoints created for machine learning model 112, and select a checkpoint to load. In response, hyperparameter evaluation module 118 may load the selected checkpoint, and evaluate machine learning model 112 using the future hyperparameter combination identified in the checkpoint. As another example, client device 150 may update conditions when checkpoints are created. For example, client device 150 may configure hyperparameter evaluation module 118 to cause checkpoint module 116 to create checkpoints for every five combinations of hyperparameters that are evaluated.

In some embodiments, client device 150 may interact with the trained model. For example, once hyperparameter evaluation model 118 determines a set of optimal hyperparameters for machine learning model 112, machine learning model 112 may be trained and deployed within network 130. For example, application 140 may host machine learning model 112 in order to generate predictions based off of queries from client device 150.

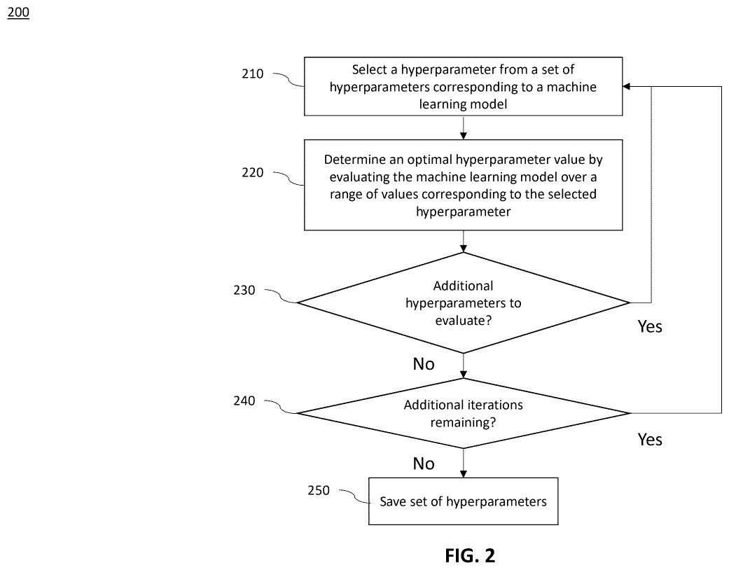

FIG. 2 illustrates a decision tree of an exemplary method 200 of a first stage for cross directional hyperparameter tuning, according to some embodiments. Method 200 shall be described with reference to FIG. 1, however, method 200 is not limited to that example embodiment.

In an embodiment, system 110 may utilize method 200 to perform an exploratory move stage of cross directional hyperparameter tuning. Method 200 may determine a first set of optimal hyperparameters corresponding to a machine learning model. The foregoing description will describe an embodiment of the execution of method 200 with respect to system 110. While method 200 is described with reference to system 110, method 200 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2.

At 210, system 110 selects a hyperparameter from a set of hyperparameters corresponding to a machine learning model. The hyperparameters may be variables with corresponding values used to configure a training process for the machine learning model. Hyperparameters may include, but are not limited to learning rate, number of training examples, number of test examples, batch size, and number of epochs

In some embodiments, hyperparameter evaluation module 118 may select the hyperparameters. The set of hyperparameters may be stored at hyperparameter store 114. In some embodiments, the set of hyperparameters may be received from client device 150. The machine learning model may be machine learning model 112.

At 220, system 110 determines an optimal hyperparameter value by evaluating the machine learning model over a range of values corresponding to the selected hyperparameter. As stated above, each hyperparameter may have a corresponding range of values at which the hyperparameter is evaluated. The range of values may be stored alongside the hyperparameters at hyperparameter store 114. In some embodiments, client device 150 may send system 110 a range of values corresponding to the hyperparameter.

System 110 may use hyperparameter evaluation module 118 to perform the evaluation. The evaluation may involve generating an evaluation metric or score based on the type of machine learning model. For example, if the model is a neural network, the evaluation score may be an f score. If the model is a decision tree, the evaluation score may be a gini impurity score. The score may be determined by training the model using the selected hyperparameter value from the range of values while the remaining, hyperparameters are fixed, and then testing the model.

For example, if the selected hyperparameter is a learning rate and it has a corresponding value range of: [0.1, 0.3, 0.5, 0.7, 0.9], hyperparameter evaluation module 118 may evaluate machine learning model 112 at each value along the range. During the iteration, remaining hyperparameters (e.g., batch size, number of epochs) remain fixed.

System 110 may save the hyperparameter value corresponding to the greatest model performance. For example, learning rate 0.7 may have resulted in greatest model performance and therefore be saved.

At 230, system 110 determines whether there are additional hyperparameters (e.g., batch size, number of epochs) to evaluate. This may be accomplished by determining whether all the hyperparameters within the set have been evaluated at 220. If there are additional hyperparameters within the set to evaluate, method 200 returns to 210, otherwise method 200 continues to 240.

At 240, system 110 determines whether there are additional iterations remaining. As discussed above, the exploratory move process may be repeated a predefined number of iterations. In some embodiments, the exploratory move process may repeat until hyperparameter value changes fall below a certain threshold or a level of model performance is reached.

At 250, system 110 saves the set of hyperparameters. The hyperparameters may be saved at hyperparameter store 114. The hyperparameters may be saved under an identifier linked to machine learning model 112.

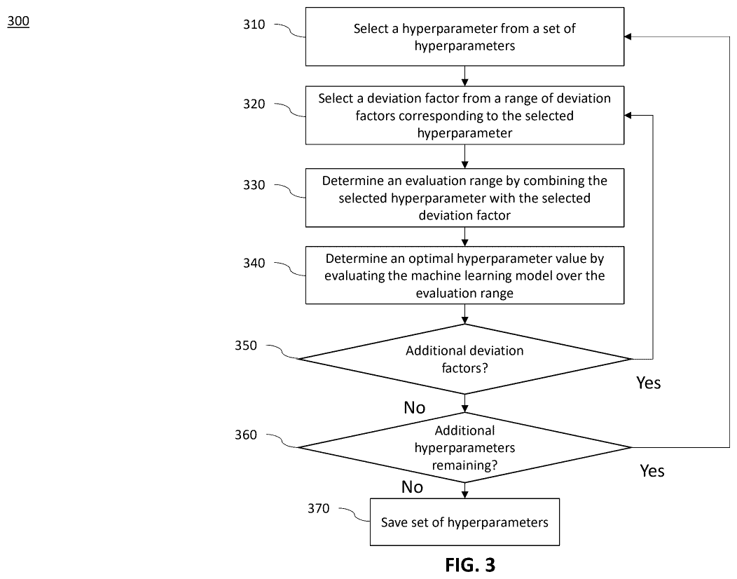

FIG. 3 illustrates a decision tree of an exemplary method 300 of a second stage for cross directional hyperparameter tuning, according to some embodiments. Method 300 shall be described with reference to FIG. 1, however, method 300 is not limited to that example embodiment.

In an embodiment, system 110 may utilize method 300 to perform a fine tuning stage of cross directional hyperparameter tuning. Method 300 may further refine the hyperparameters determined by method 200. For example, method 300 may be executed when method 200 terminates. The foregoing description will describe an embodiment of the execution of method 300 with respect to system 110. While method 300 is described with reference to system 110, method 300 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3.

At 310, system 110 selects a hyperparameter from a set of hyperparameters. In some embodiments, hyperparameter evaluation module 118 may select the hyperparameters. The set of hyperparameters may be stored at hyperparameter store 114. In some embodiments, the set of hyperparameters may be received from client device 150.

At 320, system 110 selects a deviation factor from a range of deviation factors corresponding to the selected hyperparameter. The range of deviation factors may be stored at hyperparameter store 114. In some embodiments, client device 150 may send the range of deviation factors to system 110. The range of deviation factors may include one or more percentages. For example, the range of deviation factors may be: [10%, 9%, 8%, . . . 1%]. System 110 may select the largest deviation factor within the range (e.g., 10%).

At 330, system 110 determines an evaluation range by combining the selected hyperparameter with the selected deviation factor. In some embodiments, the evaluation range may be determined by multiplying the selected deviation factor by the hyperparameter value, and then both adding and subtracting the result to the hyperparameter value. For example, the selected hyperparameter (e.g., learning rate) may have a value of 0.7 and the selected deviation factor may be 10%. Here, 0.7 is multiplied by 10% to determine a range (e.g., 0.7+/−0.07 ) of learning rates: [0.63, 0.7, 0.77].

At 340, system 110 determines an optimal hyperparameter value by evaluating the machine learning model over the evaluation range. Using the example above, machine learning model 112 may be evaluated at each learning rate: [0.63, 0.7, 0.77]. System 110 may save the hyperparameter value corresponding to the greatest evaluation score. System 110 may remove the selected deviation factor (e.g., 10%) from the range of deviation factors.

At 350, system 110 determines whether there are additional deviation factors. For example, system 110 may have evaluated the hyperparameter using 10%, but there may be remaining deviation factors to evaluate (e.g., 9% -1%). If there are additional deviation factors, method 300 returns to 320 using the optimal hyperparameter value determined at 340. For example, if 0.77 corresponded to the greatest evaluation score, 320 would use 0.77 as the selected hyperparameter to calculate the new range. If there are not additional deviation factors, method 300 continues to 360.

At 360, system 110 determines whether there are additional hyperparameters remaining. This may be accomplished by determining whether all the hyperparameters within the set have been evaluated at 310. If there are additional hyperparameters within the set to evaluate, method 300 returns to 310, otherwise method 200 continues to 370.

At 370, system 110 saves the set of hyperparameters. System 110 may save the hyperparameters at hyperparameter store 114. The hyperparameters may be stored in under an identifier of machine learning model 112.

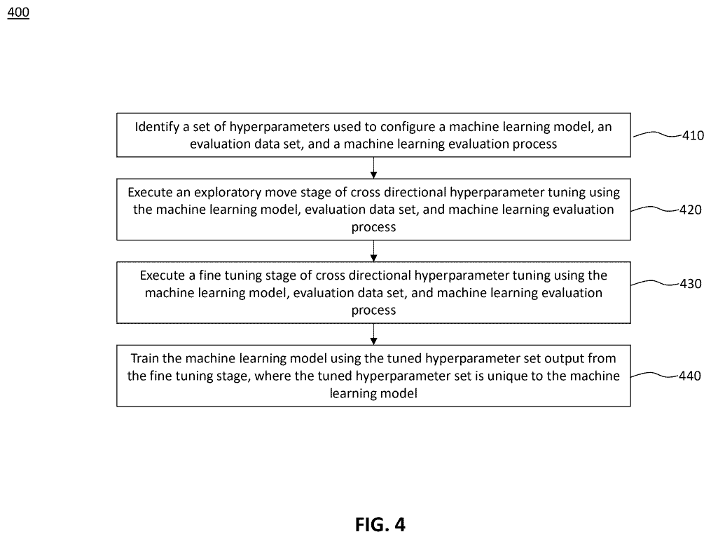

FIG. 4 depicts a flowchart illustrating an exemplary method 400 for cross directional hyperparameter tuning, according to some embodiments. Method 400 shall be described with reference to FIG. 1, however, method 400 is not limited to that example embodiment.

In an embodiment, system 110 may utilize method 400 to identify unique and optimal hyperparameters for a machine learning model. The hyperparameters may be identified via the cross directional hyperparameter tuning process. The foregoing description will describe an embodiment of the execution of method 400 with respect to system 110. While method 400 is described with reference to system 110, method 400 may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4.

At 410, system 110 identifies a set of hyperparameters used to configure a machine learning model, an evaluation data set, and a machine learning evaluation process. The machine learning model may be machine learning model 112. The set of hyperparameters may be stored at hyperparameter store 114. In some embodiments, system 110 may receive identification of the hyperparameters from client device 150. The evaluation data set may be data used by the evaluation process to generate a score for the model. The evaluation data set may be the same type of data used by the model for training, testing, and in deployment. For example, if the model is going to be trained to perform natural language tasks on English text, the evaluation data set may be English text.

The evaluation process may be used to determine the proficiency of the model configured via the hyperparameters. As stated above, hyperparameters affect model performance, and therefore model performance may be used to rank a first set of hyperparameters over a second set of hyperparameters. The evaluation process may include: (1) training the model; and (2) generating a score by testing the model. The score may relate to the model type. For example, if the model is a neural network, the score may be determined using one of accuracy, precision, recall, and f-score. If the model is a decision tree, the score may be determined using one of gini impurity, information gain, or true positive rate.

At 420, system 110 executes an exploratory move stage of cross directional hyperparameter tuning using the machine learning model, evaluation data set, and machine learning evaluation process. As discussed above, the exploratory move stage involves iterating over the set of hyperparameters, and at each iteration, selecting a hyperparameter. (e.g., learning rate). The selected hyperparameter may be a value within a range of values (e.g., 0.1-0.9). The range of values is then iterated over. In some embodiments, a step size is used to iterate over the range of values. At each iteration along the range of values a score is generated. The score may be generated using the evaluation process configured using the selected hyperparameter, set of hyperparameters, and evaluation data set. The selected hyperparameter may then be updated to the next value along the range. Once each value along the range has been evaluated, the selected hyperparameter corresponding to the greatest score may be saved. Next, an additional hyperparameter from the set of hyperparameters is selected to be evaluated. The exploratory move stage may be repeated a predefined number of times.

At 430, system 110 executes a fine tuning stage of hyperparameter tuning using the machine learning model, evaluation data set, and machine learning evaluation process. As discussed above, the fine tuning stage involves: (1) calculating a range using a hyperparameter value, and a deviation factor; (2) determining an optimal hyperparameter value within the range; (3) updating the deviation factor; and (4) repeating the process. Initially, the hyperparameter value may be the output from the exploratory move process described above. At each subsequent iteration, the hyperparameter value may be the optimal value identified at the previous iteration. The deviation factor may be a percentage and may be reduced at each iteration.

At each iteration of the process, the range may be calculated using the updated deviation factor and the optimal hyperparameter value from the previous iteration. For example, the range may be determined by multiplying the deviation factor with the optimal hyperparameter value, then adding and subtracting the product to the optimal hyperparameter value. Fine tuning may terminate once a range of deviation factors (e.g., [10%-1%]) have been evaluated. The optimal set of hyperparameters may be saved at hyperparameter store 114. The hyperparameters may be stored in association with the machine learning model (e.g., machine learning model 112).

At 440, system 110 trains the machine learning model using the tuned hyperparameter set output from the fine tuning stage (e.g., 430), where the tuned hyperparameter set is unique to the machine learning model. System 110 may use a training data set to train the machine learning model. The training data may be the same type of data used during the evaluation process. Using the example above, if the model was evaluated using English text, the training data may also be English text. The trained machine learning model may be deployed within network 130.

Method 400 may be used to determine optimal hyperparameters unique to the trained machine learning model. For example, a first machine learning model may be structured according to a transformer model architecture. The first machine learning model may be designed to perform NLP tasks using English. A second machine learning model may be built using the same structure as the first. Here, the second machine learning model may also be structured according to a transformer model architecture. However, the second machine learning model may be designed to perform NLP tasks using Spanish. Since each model (e.g., the first and second model) is designed to perform different tasks, they may use different evaluation data (e.g., English vs. Spanish text), and therefore, the resulting optimal hyperparameters may be different although the models have the same architecture.

For example, method 400 may be used to determine a first set of tuned hyperparameters for a first machine learning model, where the first set of tuned hyperparameters are unique to the first machine learning model. Method 400 may be executed using the first machine learning model, an evaluation process, and a first evaluation data set used in the evaluation process. Method 400 may further be used to determine a second set of tuned hyperparameters for a second machine learning model, where the second set of tuned hyperparameters are unique to the second machine learning model. Here, method 400 may be executed using the second machine learning model, the evaluation process, and a second evaluation data set. Once the tuned hyperparameters are determined, the models may be trained and deployed. The models may be trained with their respective tuned hyperparameters and training data. For example, the first machine learning model may be trained using the first set of tuned hyperparameters and a first training data set, and the second machine learning model may be trained using the second set of tuned hyperparameters and a second training data set. Once trained, the models may be used.

The models may be deployed within network 130. For example, application 140-1 may host the first trained machine learning model, and application 140-2 may host the second trained machine learning model. Each application (e.g. application 140-1 and application 140-2) may receive queries via network 130. The queries may originate from connected devices such as client device 150. Each application may further use its respective machine learning model to generate predictions. The generated predictions may be returned to the connected device (e.g., client device 150).

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
identifying a set of hyperparameters used to configure a first machine learning model, a first evaluation data set, and a machine learning evaluation process;
determining a first set of tuned hyperparameters for the first machine learning model by performing cross directional hyperparameter tuning, comprising:
iterating over the set of hyperparameters, at each iteration:
selecting a hyperparameter from the set of hyperparameters, wherein the selected hyperparameter is a value within a range of values;
iterating over the range of values, at each iteration:
generating a score for the machine learning model via an evaluation process, wherein the evaluation process is configured using the selected hyperparameter, set of hyperparameters, and the first evaluation data set;
updating the selected hyperparameter; and
saving the selected hyperparameter corresponding to a greatest score at the set of hyperparameters.

2. The computer implemented method of claim 1, wherein the first machine learning model is structured according to an architecture, wherein the method further comprises:
determining a second set of tuned hyperparameters for a second machine learning model by performing cross directional hyperparameter tuning using a second evaluation data set,
wherein the second machine learning model is structured according to the architecture; and
wherein the second set of tuned hyperparameters are unique to the second machine learning model; and
training the second machine learning model using the second set of tuned hyperparameters and a second training data set.

3. The computer implemented method of claim 1, wherein iterating over the range of values is repeated a predefined number of times, and at each iteration the range is updated based on a percentage and the hyperparameter corresponding to the greatest score from a previous iteration.

4. The computer implemented method of claim 3, wherein the percentage is reduced at each iteration.

5. The computer implemented method of claim 1, wherein the machine learning model is a decision tree and the set of hyperparameters includes any of learning rate, maximum number of steps, number of keys, number of trees, minimum child weight, and tree depth.

6. The computer implemented method of claim 5, wherein the score is determined using one of gini impurity, information gain, or true positive rate.

7. The computer implemented method of claim 1, wherein the machine learning model is a neural network, and the set of hyperparameters includes any of learning rate, number of layers, number of nodes per layer, activation function, drop-out rate, training epochs, and batch size.

8. The computer implemented method of claim 1, wherein the score is determined using one of accuracy, precision, recall, and f-score.

9. A system, comprising:
a memory; and
at least one processor coupled to the memory and configured to:
identify a set of hyperparameters used to configure a first machine learning model, a first evaluation data set, and a machine learning evaluation process;
determine a first set of tuned hyperparameters for the first machine learning model by performing cross directional hyperparameter tuning, comprising:
iterating over the set of hyperparameters, at each iteration:
selecting a hyperparameter from the set of hyperparameters, wherein the selected hyperparameter is a value within a range of values;
iterating over the range of values, at each iteration:
generating a score for the machine learning model via an evaluation process, wherein the evaluation process is configured using the selected hyperparameter, set of hyperparameters, and the first evaluation data set;
updating the selected hyperparameter; and
saving the selected hyperparameter corresponding to a greatest score at the set of hyperparameters.

10. The system of claim 9, wherein the first machine learning model is structured according to an architecture, wherein the method further comprises:
determining a second set of tuned hyperparameters for a second machine learning model by performing cross directional hyperparameter tuning using a second evaluation data set,
wherein the second machine learning model is structured according to the architecture; and
wherein the second set of tuned hyperparameters are unique to the second machine learning model; and
training the second machine learning model using the second set of tuned hyperparameters and a second training data set.

11. The system of claim 9, wherein iterating over the range of values is repeated a predefined number of times, and at each iteration the range is updated based on a percentage and the hyperparameter corresponding to the greatest score from a previous iteration.

12. The system of claim 11, wherein the percentage is reduced at each iteration.

13. The system of claim 9, wherein the machine learning model is a decision tree and the set of hyperparameters includes any of learning rate, maximum number of steps, number of keys, number of trees, minimum child weight, and tree depth.

14. The system of claim 13, wherein the score is determined using one of gini impurity, information gain, or true positive rate.

15. The system of claim 9, wherein the machine learning model is a neural network, the set of hyperparameters includes any of learning rate, number of layers, number of nodes per layer, activation function, drop-out rate, training epochs, and batch size, and the score is determined using one of accuracy, precision, recall, and f-score.

16. A non-transitory computer-readable device having instructions stored thereon that, when executed by at least one computing device, cause the at least one computing device to perform operations comprising:
identifying a set of hyperparameters used to configure a first machine learning model, a first evaluation data set, and a machine learning evaluation process;
determining a first set of tuned hyperparameters for the first machine learning model by performing cross directional hyperparameter tuning, comprising:
iterating over the set of hyperparameters, at each iteration:
selecting a hyperparameter from the set of hyperparameters,
wherein the selected hyperparameter is a value within a range of values;
iterating over the range of values, at each iteration:
generating a score for the machine learning model via an evaluation process, wherein the evaluation process is configured using the selected hyperparameter, set of hyperparameters, and the first evaluation data set;
updating the selected hyperparameter; and
saving the selected hyperparameter corresponding to a greatest score at the set of hyperparameters.

17. The non-transitory computer-readable device of claim 16, wherein the first machine learning model is structured according to an architecture, wherein the method further comprises:
determining a second set of tuned hyperparameters for a second machine learning model by performing cross directional hyperparameter tuning using a second evaluation data set,
wherein the second machine learning model is structured according to the architecture; and
wherein the second set of tuned hyperparameters are unique to the second machine learning model; and
training the second machine learning model using the second set of tuned hyperparameters and a second training data set.

18. The non-transitory computer-readable device of claim 17, wherein iterating over the range of values is repeated a predefined number of times, and at each iteration the range is updated based on a percentage and the hyperparameter corresponding to the greatest score from a previous iteration.

19. The non-transitory computer-readable device of claim 16, wherein the machine learning model is a decision tree, the set of hyperparameters includes any of learning rate, maximum number of steps, number of keys, number of trees, minimum child weight, and tree depth, and the score is determined using one of gini impurity, information gain, or true positive rate.

20. The non-transitory computer-readable device of claim 16, wherein the machine learning model is a neural network, the set of hyperparameters includes any of learning rate, number of layers, number of nodes per layer, activation function, drop-out rate, training epochs, and batch size, and the score is determined using one of accuracy, precision, recall, and f-score.
